(19) United States
(12) Patent Application Publication
(10) Pub. No.: US 2005/0212897 A1
(43) Pub. Date: Sep. 29, 2005

(54) Thermal printer having heat radiation plate

(75) Inventors: Takashi Goto, Fukushima-ken (JP); Yasutoshi Inoue, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/087,954

(22) Filed: Mar. 22, 2005

(30) Foreign Application Priority Data
Mar. 26, 2004 (JP) 2004-092384
Jun. 24, 2004 (JP) 2004-186783

(51) Int. Cl. B41J 2/32; B41J 2/335

(52) U.S. Cl. 347/220

(57) ABSTRACT

A thermal printer includes a rotatable platen roller; an elongated thermal head which is movable toward or away from the platen roller; and a head supporting member having an elongated head supporting portion for supporting the thermal head formed at an end. A heat radiation plate through which heat generated from the thermal head during printing can escape is arranged between the thermal head and the head supporting portion, and the thermal head can be adjustably curved toward the platen roller via the heat radiation plate by an adjusting member arranged in the head supporting portion.

### BACKGROUND OF THE INVENTION

1. Field of the Invention

The present invention relates to a thermal printer which is suitable for performing printing on a recording paper by selectively generating heat from a plurality of heating elements of a thermal head based on print information.

2. Description of the Related Art

A conventional thermal printer 51 will now be described with reference to FIGS. 5 and 6, a cylindrical platen roller 52 is rotatably supported on a frame side which is not shown. Also, above the platen roller 52, a rectangular thermal head 53 composed of line heads capable of moving toward or away from (head up/down) the platen roller 52 is arranged.

The thermal head 53 is composed of a head substrate 53a which has a plurality of heating elements (not shown) formed on the bottom of the drawing, a head mount 53b on which the head substrate 53a is mounted, and a ribbon separation plate 53c.

Also, the thermal head 53 is supported by a head supporting member 54 so as to be movable toward and away from the platen roller 52. The head supporting member 54 includes a first head supporting member 55 having a pair of first substantially U-shaped arm portions 55a which face each other, a second head supporting member 56 having second substantially U-shaped arm portions 56a which are formed outside facing the first arm portions.

The first head supporting member 55 is made of materials such as aluminum whose heat radiation performance is satisfactory, a flat plate head supporting portion 55b which also serves as a heat radiation plate is integrally formed at the ends, on the left side in the drawing, of a pair of the first arm portions 55a, a heat radiation portion 55c is formed by extending to the right side in the drawing from the head supporting portion 55b to have the large area.

Also, in the first head supporting member 55, both ends of the thermal head 53 in the longitudinal direction are mounted below the head supporting portion 55b, heat generated during printing operation escapes from the heat radiation portion 55c via the head supporting portion 55b which also serves as a heat radiation plate.

Also, in the second head supporting member 56, left ends of a pair of the second arm portions 56a are integrally formed by connecting to an urging portion 56b with screws. A coil spring 57 is arranged between the urging portion 56b and the head supporting portion 55b of the first head supporting member 55, the thermal head 53 mounted in the head supporting portion 55b is elastically urged toward the platen roller 52.

Also, in the first head supporting member 55, a pair of stopper portions 55d is curved and folded in a nonlinear form to prevent a gap between the head supporting portion 55b and the urging portion 56b from increasing by the urging force of the coil spring 57.

Also, in the first head supporting member 55, an adjusting screw 58 capable of adjusting the warpage of the thermal head 53 is fixed to the center position of the head supporting portion 55b in the length direction.

Also, in the first head supporting member 55, a first supporting hole 55f which is elongated in the vertical direction in the drawing is formed at ends on the right side, in the drawing, of a pair of the first substantially U-shaped arm portions 55a, and a second circular supporting hole 56c is formed at ends on the right side in the drawing of the second arm portions 56a located outside the first supporting hole.

Also, in the second head supporting member 56, a urging portion 56d is protrudingly formed in a rod shape at ends on the right side in the drawing of the second arm portions 56a, the urging portion 56d is designed to be engaged with a urging member (not shown) arranged at the frame side.

Also, in the head supporting member 54, the first and second supporting holes 55f and 56c are supported by a supporting shaft (not shown) formed at the frame side, and when being rotated in the lower direction (of the drawing) by the urging means, the thermal head 53 is turned down and can pressure-contacted to the platen roller 52 by the urging force of the coil spring 57.

Also, in the thermal head 53, the center portion in the longitudinal direction is bent downward (in the drawing), so as to prevent an ink ribbon (not shown), which is pressure-contacted to the platen roller 52 by a recording paper when the printing operation is performed, from being wrinkled.

However, in the conventional thermal printer 51, because the adjusting screw 58 is supported by the head supporting portion 55b which also serves as a heat radiation plate, when the thermal head 53 is bent by tightening the adjusting screw 58, the center portion in the longitudinal direction of the head mount 53b is separated from the head supporting portion 55b and a gap 59 is formed therein.

Because of this, heat generated from the thermal head 53 during printing can not easily escapes through the head supporting portion 55b which also serves as a heat radiation plate, resulting in the thermal head 53 to heat up during the printing process, thus deterioration in the quality of image printed on a recording paper may occur.

Also, in the first head supporting member 55, because the first arm portions 55a, the head supporting portion 55b and the heat radiation portion 55c are made of materials such as aluminum whose heat radiation performance is satisfactory, thus the cost increases.

Furthermore, the thickness of the head supporting portion 55b made of materials like aluminum must be thick because the thermal head 53 is bent by tightening the adjusting screw 58, which increases the cost.

### SUMMARY OF THE INVENTION

An advantage of the present invention is that it provides a thermal printer capable of radiating heat generated from a thermal head during, printing a high image quality, and reducing cost.

According to a first aspect of the present invention, the thermal printer includes a rotatable platen roller; an elongated thermal head which is movable toward or away from the platen roller; and a head supporting member having an elongated head supporting portion for supporting the thermal head formed at an end. A heat radiation plate through which heat generated from the thermal head during printing can escape is arranged between the thermal head and the head supporting portion and the thermal head can be adjustably curved toward the platen roller via the heat radiation plate by an adjusting member arranged in the head supporting portion. By this, because the thermal head can be curved in a state adhering closely to the heat radiation plate, heat generated from thermal head during printing can reliably escape via the heat radiation plate, thus the thermal head can be immediately cooled down to an appropriate temperature for printing, therefore, it is achievable to print excellent quality images at a high rate of speed.

Further, according to a second aspect of the invention, the heat radiation plate is composed of a rectangular head fixing portion for fixing the thermal head, a heat radiation portion having a wide surface extending from the head fixing portion. The head fixing portion is supported by the head supporting portion, then by curving the center portion in the longitudinal direction of the head fixing portion with the adjusting member, the thermal head can be adjustably curved. By this, the thermal head can be reliably curved along the curved heat radiation plate, the thermal head always adheres closely to the heat radiation plate, thus heat of the thermal head immediately and reliably escape via the heat radiation plate.

Furthermore, according to a third aspect of the invention, the head fixing portion has a pair of slit grooves formed at a predetermined interval in the center portion in the direction orthogonal to the longitudinal direction, a pressing portion between the slit grooves can be pressed by the adjusting member. By this, because the heat radiation plate can be curved at the slit grooves with little strength, the thickness of the flat plate head supporting portion supporting the adjusting member can be made thin, it is achievable to reduce the cost of the materials. Further, by the slit grooves, the head fixing portion can be securely curved in the form of a mountain, thus an ink ribbon can be prevented from being wrinkled when the printing is performed.

Moreover, according to a fourth aspect of the invention, the adjusting member is composed of screw members screwed to the head supporting portion, and by screwing the screw members, the thermal head can be adjustably curved via the heat radiation plate. By this, the curve adjustment of the thermal head becomes easy.

In addition, according to a fifth aspect of the invention, the head supporting member has a pair of arm portions capable of supporting both ends of the longitudinal direction of the head supporting portion, the arm portion has a rotation supporting portion formed opposite to the head supporting portion, and by rotating around the rotation supporting portion as a fulcrum, the head supporting portion is movable toward or away from the platen roller. By this, the thermal head can reliably pressure-contact the platen roller.

### BRIEF DESCRIPTION OF THE DRAWINGS

FIG. 1 is a perspective view showing a printing part of a thermal printer or the present invention;

FIG. 2 is a diagrammatic plan view of FIG. 1;

FIG. 3 is a perspective view showing a heat radiation plate according to the present invention;

FIG. 4 is a perspective view showing a modification of a heat radiation plate according to the present invention;

FIG. 5 is a perspective view showing a printing part of a conventional thermal printer; and

FIG. 6 is a diagrammatic plan view of FIG. 5.

### DETAILED DESCRIPTION OF THE PREFERRED EMBODIMENTS

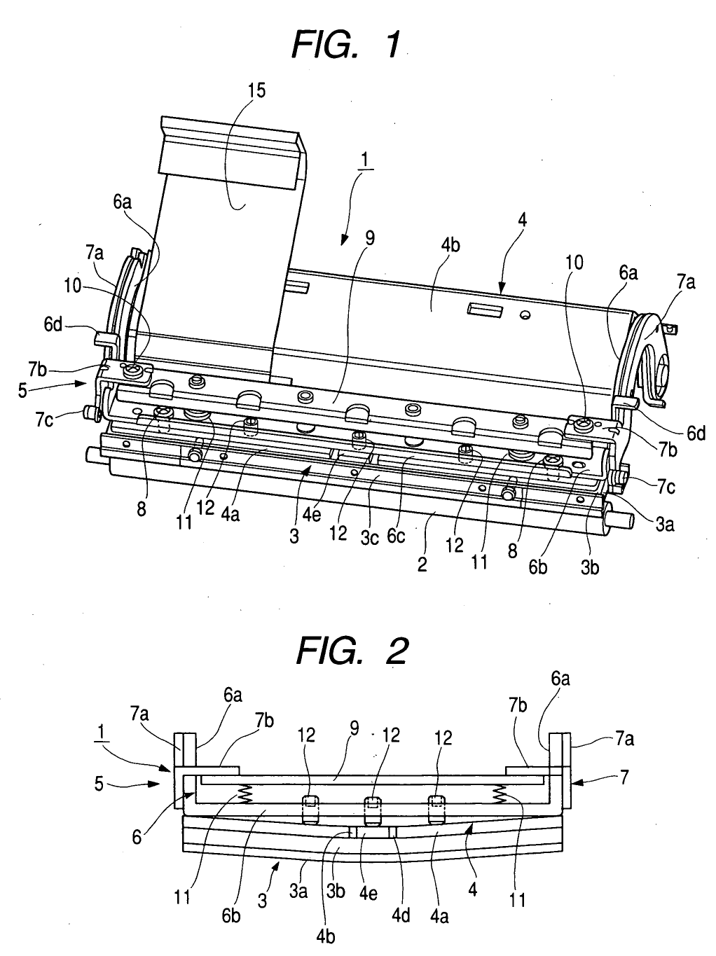

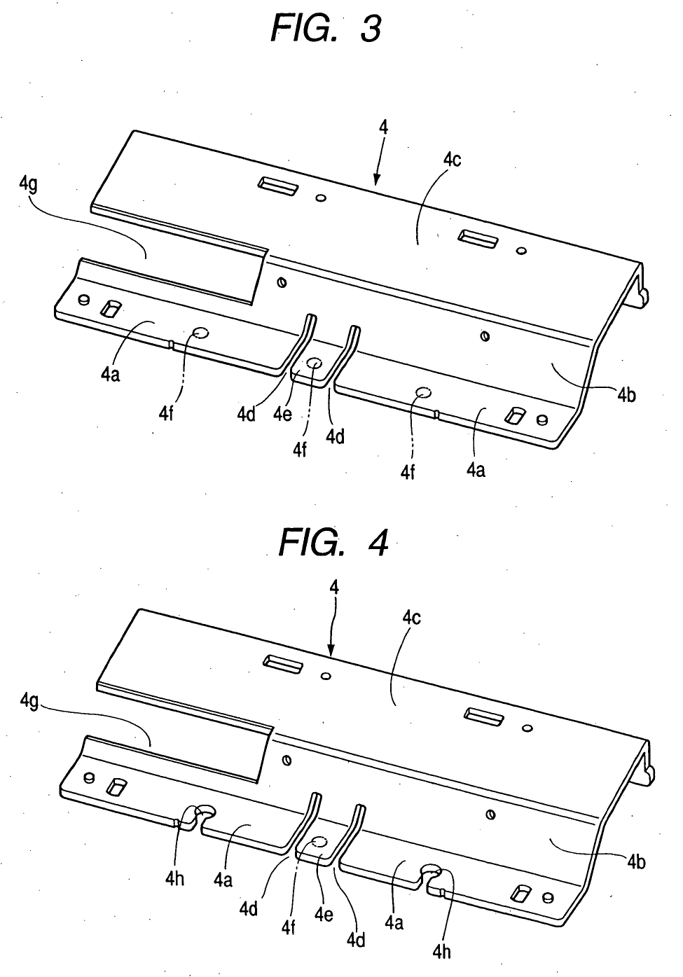

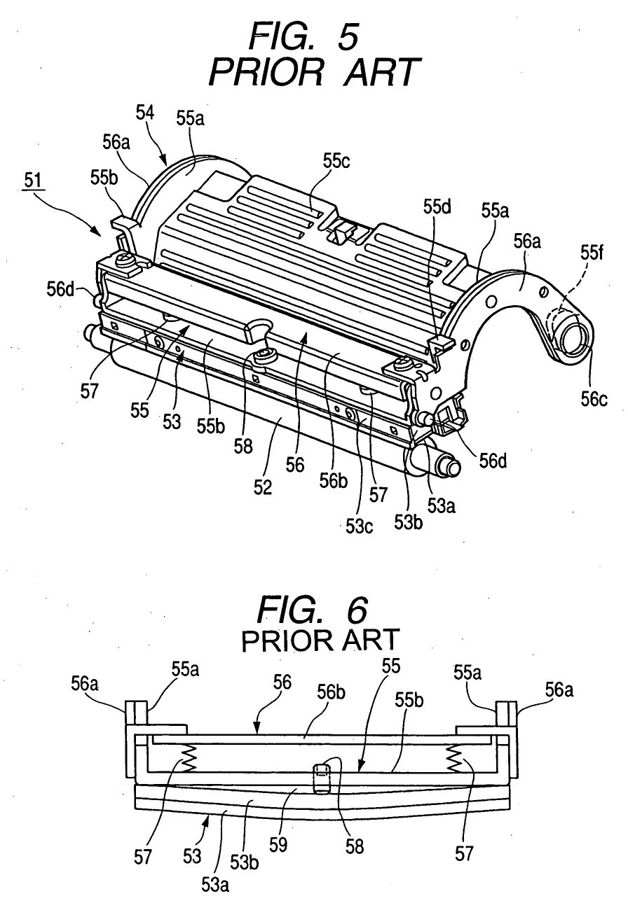

Hereinafter, a preferred embodiment of a thermal printer of the present invention will now be described with reference to the accompanying drawings. FIG. 1 is a perspective view showing a printing part of a thermal printer or the present invention, FIG. 2 is a diagrammatic plan view of FIG. 1, FIG. 3 is a perspective view showing a heat radiation plate according to the present invention, FIG. 4 is a perspective view showing a modification of a heat radiation plate according to the present invention.

First, the thermal printer of the present invention will be described with reference to FIGS. 1 to 3. An elongated cylindrical platen roller 2 is rotatably supported on the frame side (not shown).

Also, above the platen roller 2, an elongated cylindrical thermal head 3 composed of line heads being movable toward or away from (head up/down) the platen roller 2 is arranged.

As shown in FIG. 2, the thermal head 3 includes a head substrate 3a which has a plurality of heating elements (not shown) arranged in a row at the bottom, the substrate 3a is bonded to a head mount 3b made of aluminum or the like with a high thermal conductive adhesive. At the front side of the thermal head 3 in FIG. 3, a separation plate 3c is fixed with screws or the like and separates an ink ribbon contacted to a recording paper (not shown) during printing.

Further, above the head mount 3b, a heat radiation plate 4 made of aluminum or the like is bonded with a high thermal conductive adhesive.

In the heat radiation plate 4, as shown in FIG. 3, a rectangular head fixing portion 4a for fixing the head mount 3b of the thermal head 3 is formed, the heat radiation plate is extended from the head fixing portion 4a in the direction of the rear side of the drawing, a connecting portion 4b having a wide size and a heat radiation portion 4c are curved and folded in a crank form.

Furthermore, the heat generated from the thermal head 3 generated during printing is immediately radiated by transferring the heat to the heat radiation portion 4c via the head fixing portion 4a.

Moreover, in the center portion in the longitudinal direction of the head fixing portion 4a, as shown in FIG. 3, in the direction orthogonal to the longitudinal direction, a pair of slit grooves 4d is formed at a predetermined interval, and the area of the head fixing portion 4a interposed between the slit grooves is a pressing portion 4e.

In addition, a pressing position 4f of the pressing portion 4e indicated by a two-dot chain line is pressed by an adjusting member 12 which will be described later.

Also, two pressing positions 4f, 4f, indicated by the two-dot chain line, located in other portions besides the pressing portion 4e of the head fixing portion 4a can be pressed by other adjusting member 12.

Also, in the heat radiation plate 4, a circuit drawing opening 4g is formed with a predetermined size at the left side in the drawing of the connecting portion 4b (in the drawing), FPC 15 forming circuit patterns to be connected to a plurality of heating elements of the thermal head 3 can be drawn out from the opening 4g.

The thermal head 3 is supported at an end of a head supporting member 5 via the head radiation plate 4 and is movable toward or away from (head up/down) the platen roller 2.

Also, the head supporting member 5 is composed of a first head supporting member 6, made of a steel plate or the like and having a pair of first arm portions 6a which is substantially U-shaped and facing each other, a second head supporting member 7, made of a steel plate or the like and having second arm portions 7a, 7a which are substantially U-shaped and face each other in the outside opposite to the first arm portions 6a.

In the first head supporting member 6, an end (in the front of the drawing) of a pair of the first arm portions 6a is integrally contacted to a flat plate head supporting portion 6b.

Also, in the head supporting portion 6b, front side (in the drawing) is bent upwardly to form a reinforcing rib 6c, which improves strength.

Also, below the head supporting portion 6b of the first head supporting member 6, both ends in the longitudinal direction of the fixing portion 4a of the head radiation plate 4 are fixed by the screw members 8. Also, in the second head supporting member 7, ends (in the front of the drawing) of a pair of the second arm portions 7a are bent at a right angle with respect to the inner sides facing each other to respectively form mounting portions 7b.

In the mounting portions 7b, an urging member 9 which is bent in a substantially L shape, taken from a side view, is fixed by screws 10, a pair of the second arm portions 7a, 7a is integrally connected.

Also, a coil spring 11 is arranged between the urging member 9 and the head supporting portion 6a of the first head supporting member 6, the thermal head 3 mounted to the head supporting portion 6 via the heat radiation plate 4 is elastically urged to the platen roller 2.

Also, in the first head supporting member 6, a pair of stopper portions 6d is formed being bent outward so as to prevent a gap between the head supporting portion 6b and the urging member 9 from by the urging force of the coil spring 11.

Also, the stopper portions 6d and the first arm portions 7a, 7a of the second head supporting member 7 whose gap is increased by the urging force of the coil spring 11, abut each other, the space between the head supporting portion 6b and the urging member 9 is not allowed to be increased over a predetermined size.

Because of this, the thermal head 3 supported by the head supporting portion 6b is always elastically urged toward the platen roller 2 located at the bottom.

Furthermore, in the head supporting portion 6b of the first head supporting member 6, the adjusting member 12 composed of three screw members is arranged at a predetermined interval within a pair of screw members 8, for example, by fastening screws at three positions.

By screwing the adjusting member 12 composed of the screw members screwed to the head supporting portion 6b, a pressing position 4f of the head fixing portion 4a indicated by a two-dot chain line is pressed downward.

Then, the head fixing portion 4a compressed by the adjusting member 12 can be curved naturally by slit grooves 4d, 4d for adjusting such that the pressing portion 4e in the center position become the highest convex with little strength.

Because of this, the first head supporting member 6 can prevent the warpage of the head supporting portion 6b even though the thickness of the head supporting portion 6b for supporting the adjusting member 12 is made thin, thereby the adjusting member 12 compresses the heat radiation plate 4.

Further, as shown in FIG. 2, if the fixing portion 4a is curved in the form of a mountain by screwing the adjusting member 12, the thermal head 3 is curved in the form of a mountain along the above curve.

Namely, the thermal head 3 is curved in a state that the head fixing portion 4a of the heat radiation plate 4 adheres closely to the thermal head 3. Therefore, heat reserve of the thermal head 3 generated during printing can immediately escape through the heat radiation plate 4.

Further, in the second head supporting member 7, urging portions 7c are respectively formed in a rod shape protruding outward from each end in front in the drawing of a pair of the second arm portions 7a. The urging portions 7c are engaged with an urging member (not shown) arranged on the frame side.

In the head supporting member 5 like this, other ends (on the rear side in the drawing) of the first and second arm portions 6a, 7a is supported by a supporting shaft formed at the frame (not shown), if the urging portion 7c is pushed downward (in the drawing) by the urging member, the end on front side in the drawing) rotates around the other end (on the rear side in the drawing) as a fulcrum.

Also, if the end of the head supporting member 5 rotates downward, the thermal head 3 moves down and abuts the platen roller 2. If the thermal head 3 abuts the platen roller 2, the rotation of the first head supporting member 6 stops, but, the second head supporting member 7 rotates downward again.

By this, the head supporting portion 6b is elastically urged downward by the coil spring 11, thus the thermal head 3 pressure-contacts the platen roller 2 via the head radiation plate 4.

Further, in the thermal head 3 which pressure-contacts the platen roller 2, the central position of the longitudinal direction is bent downward (in the drawing) by about 70 μm interposing the heat radiation plate 4 by the adjusting member 12. Because of this, an ink ribbon (not shown) which is drawn between the thermal head 3 and the platen roller 2 when the printing is performed and is pressure-contacted to a recording paper (not shown) is prevented from being wrinkled.

In the thermal printer 1 of the present invention, as shown in FIG. 2, because the curve of the thermal head 3 is adjusted by the adjusting member 12 by using the heat radiation plate 4, the heat radiation plate 4 always adheres closely to the thermal head 3.

Because of this, heat generated from the thermal head 3 during printing operation is performed can be reliably escaped via the heat radiation plate 4.

Also, even though the thermal head 3 heats up during printing process, the heat is immediately cooled down to an appropriate temperature for printing, therefore, it is achievable to print excellent quality images at a high rate of speed.

Further, in the preferred embodiment of the present invention, the head supporting member 5 was described as the combination of the first and second head supporting members 6 and 7, respectively, but the head supporting member 5 can be constructed by the first head supporting member 6 only so that the urging force is applied on the first head supporting member 6 to make it rotate.

Further, in the head fixing portion 4a of the head radiation plate 4 of the present invention, it was described that not only the pressing portion 4e interposed between the slit grooves 4d but also other portions are pressed by the adjusting member 12. But, as a modification of the heat radiation plate 4, in the pressing position 4f besides the pressing portion 4e indicated by a two-dot chain line, relief holes 4h, 4h are formed as shown in FIG. 4, only the pressing portion 4e of the center portion is pressed by the adjusting member 12, the rest adjusting members 12 are positioned at the relief holes 4h, 4h, so the thermal head 3 can be pressed.

By utilizing the heat radiation plate 4 according to a modification, for example, even though stress balance on the right and left side of the heat fixing portion 4a are differ from each other due to the circuit drawing opening 4g, the thermal head 3 can be appropriately bent in the form of a mountain uniformly in left and right sides by the adjusting member 12 which presses the pressing portion 4e of the center portion only.

1. A thermal printer comprising:
a rotatable platen roller;
an elongated thermal head which is movable toward or away from the platen roller; and
a head supporting member having an elongated head supporting portion for supporting the thermal head formed at an end;
wherein a heat radiation plate through which heat generated from the thermal head during printing can escape is arranged between the thermal head and the head supporting portion; and
wherein the thermal head can be adjustably curved toward the platen roller via the heat radiation plate by an adjusting member arranged in the head supporting portion.

2. The thermal printer according to claim 1,
wherein the heat radiation plate is composed of a rectangular head fixing portion for fixing the thermal head, a heat radiation portion having a wide surface extending from the head fixing portion,
wherein the head fixing portion is supported by the head supporting portion, then by curving a center portion in a longitudinal direction of the head fixing portion with the adjusting member, the thermal head can be adjustably curved.

3. A thermal printer according to claim 2,
wherein the head fixing portion has a pair of slit grooves formed at a predetermined interval in the center portion in a direction orthogonal to the longitudinal direction, a pressing portion between the slit grooves can be pressed by the adjusting member.

4. A thermal printer according to claim 1,
wherein the adjusting member is composed of screw members screwed to the head supporting portion, and by screwing the screw members, the thermal head can be adjustably curved via the heat radiation plate.

5. A thermal printer according to claim 1,
wherein the head supporting member has a pair of arm portions capable of supporting both ends of the longitudinal direction of the head supporting portion, the arm portion has a rotation supporting portion formed to be opposite to the head supporting portion, and by rotating around the rotation supporting portion as a fulcrum, the head supporting portion is movable toward or away from the platen roller.

6. A thermal printer according to claim 2,
wherein the adjusting member is composed of screw members screwed to the head supporting portion, and by screwing the screw members, the thermal head can be adjustably curved via the heat radiation plate.

7. A thermal printer according to claim 2,
wherein the head supporting member has a pair of arm portions capable of supporting both ends of the longitudinal direction of the head supporting portion, the arm portion has a rotation supporting portion formed to be opposite to the head supporting portion, and by rotating around the rotation supporting portion as a fulcrum, the head supporting portion is movable toward or away from the platen roller.

8. A thermal printer according to claim 3,
wherein the head supporting member has a pair of arm portions capable of supporting both ends of the longitudinal direction of the head supporting portion, the arm portion has a rotation supporting portion formed to be opposite to the head supporting portion, and by rotating around the rotation supporting portion as a fulcrum, the head supporting portion is movable toward or away from the platen roller.
